(19) United States
(12) Patent Application Publication
(10) Pub. No.: US 2006/0141239 A1
(43) Pub. Date: Jun. 29, 2006

(54) Method for making a bonded foam product suitable for use as an underlayment for floor coverings

(76) Inventor: Stephen D. Gilder, Collierville, TN (US)

Correspondence Address: CONLEY ROSE, P.C., 5700 GRANITE PARKWAY, SUITE 330, PLANO, TX, 75024, US

(21) Appl. No.: 11/024,069

(22) Filed: Dec. 28, 2004

(51) Int. Cl. B32B 3/26

(52) U.S. Cl. 428/318.6; 428/319.3; 428/319.7; 525/330.9

(57) ABSTRACT

A pre-polymer comprising: isocyanate, polyol, oil, and an amine catalyst and an associated method for producing a polyurethane bonded foam product. The method comprises: coating a plurality of foam pieces with the pre-polymer; compressing the foam pieces into a foam log of a desired density; and steaming the foam log to cure the pre-polymer. Preferably, the amine catalyst is dimorpholinodiethylether (DMDEE) and the isocyanate, the polyol, and the oil are present in the pre-polymer in about equal amounts.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The present disclosure relates generally to methods for making bonded foam products and specifically to a method for using an amine catalyst to reduce the steam time required to cure the pre-polymer in a bonded polyurethane foam log used to make bonded polyurethane foam products such as underlayments for floor coverings.

In its broadest sense, a floor is comprised of a subfloor over which a decorative covering is installed. Typically, the subfloor is either a slab of concrete or one or more sheets of plywood supported by a combination of joists, beams, posts and, in multiple-story buildings, bearing walls. The primary types of floor coverings used in structures are “soft” floor coverings and “hard” floor coverings. As its name suggests, soft floor coverings are soft, quiet underfoot, and tend to yield upon application of a force thereto. Hard floor coverings, on the other hand, are hard and rigid, but tend to be durable and easy to maintain.

Generally, an underlayment is installed between the subfloor and the floor covering. The underlayment provides a cushion, decreases the wear, and allows for more efficient cleaning of the floor covering. Underlayment also smoothes imperfections in the subfloor. Cushioning is important for both hard floor coverings and soft floor coverings, although the type of underlayment varies for each application. Hard floor coverings, such as wood, tend to have thinner, denser underlayments that absorb the sound of a person walking on the hard floor coverings. Soft floor coverings, such as carpet, tend to have thicker, less dense underlayment to enhance the softness of the soft flooring product. In addition, by smoothing high points (or “peaks”), low points (or “valleys”) and other irregularities in the subfloor, underlayments may also provide a more level surface for floor coverings.

Underlayments are made out of various different types of materials. Some underlayments are made out of nonwoven fiber batts. Other underlayments are made out of foam coated onto a woven or nonwoven fabric scrim or substrate. Foam rubber or latex can also be used as underlayment. Additionally, underlayment can be composed of prime polyurethane foam, which is cut to various thicknesses from larger foam blocks. These prime polyurethane blocks do not incorporate the use of ground, recycled scrap polyurethane into the process as in re-bonded foam. Prime foam is produced by mixing various chemical compounds together to create highly cross-linked polyurethane chains where density is primarily controlled by the amount of water in the formulation, and to a lesser extent, the degree of off-gassing resulting from the reaction of water and isocyanate, which influences the degree of cell expansion. Perhaps the most common type of underlayment is bonded foam underlayment.

Bonded foam underlayment is manufactured by shredding scrap foam into small pieces and then forming a larger piece of bonded foam from the shredded pieces of scrap foam. After the scrap foam is shredded, the foam pieces are coated with a pre-polymer comprised of isocyanate and polyol, and compressed into a foam log. Moisture is then added to the foam log to cure the pre-polymer. Typically, the time required to cure the pre-polymer has been on the order of two to ten minutes. It should be readily appreciated that, if the curing time for the pre-polymer is decreased from the aforementioned curing times, the foam log will be produced faster, thereby increasing the productivity of the process. Thus, a need exists for a method of decreasing the curing time for the pre-polymer used to adhere foam pieces together to form bonded foam.

While some adhesives, such as those used to bond together wood, metal, and glass, have faster curing times than those traditionally used to bond foam pieces, such adhesives are not suitable for adhering together the foam pieces which form bonded foam. More specifically, the existing fast curing adhesives used to bond together wood, metal, and glass are characterized by a high viscosity, typically, at least 5,000 centipoises, which makes it difficult to uniformly coat the foam pieces with adhesive. The high viscosity of the adhesive would also increase the complexity, as well as the cost, of the equipment required to make bonded foam. Consequently, a further need exists for a fast curing, bonded foam pre-polymer having a sufficiently low viscosity which allows uniform coating of the foam pieces.

### SUMMARY OF THE INVENTION

The present invention is directed to a pre-polymer comprised of isocyanate, polyol, oil, and an amine catalyst such as dimorpholinodiethylether (DMDEE). The pre-polymer may further comprise an antimicrobial chemical compound and/or a flame retardant (FR) chemical compound. In various further compositions of thereof, the pre-polymer may contain about equal amounts of the isocyanate, the polyol, and the oil, and/or between about 0.5 percent and about 5 percent of the amine catalyst. In another embodiment, the ratio of catalyst to polyol may be between about 1:20 and about 1:40. In still another embodiment, the pre-polymer may have a viscosity between about 100 centipoises and 1,000 centipoises.

The pre-polymer hereinabove described may used in a method for producing polyurethane foam products such as bonded form underlayment. The polyurethane foam products are produced by coating a plurality of foam pieces with the pre-polymer, compressing the foam pieces into a foam log of a desired density, and steaming the foam log to cure the pre-polymer. It has been discovered that the inclusion of the catalyst reduces the cure time for the foam log by thirty percent over methods not employing the catalyst. It has been further discovered that the inclusion of the catalyst reduces the amount of steam required to cure the foam log by thirty percent over methods not employing the catalyst. Variously, the foam log may be produced in a continuous extruder and/or the foam pieces may be used to form the foam log may be substantially moisture-free.

In another aspect, the present invention is directed to a method for producing a polyurethane foam product by coating a plurality of foam pieces with a pre-polymer comprised of isocyanate, polyol, and an amine catalyst, compressing the foam pieces into a foam log of a desired density, and steaming the foam log to cure the pre-polymer. It has been discovered that the inclusion of the catalyst reduces the cure time for the foam log by thirty percent over methods not employing the catalyst. It has been further discovered that the inclusion of the catalyst reduces the amount of steam required to cure the foam log by thirty percent over methods not employing the catalyst. Variously, the foam log may be produce using a continuous extruder, the foam pieces used to produce the log may be substantially moisture-free, and/or the amine catalyst may be DMDEE. The pre-polymer may have a viscosity between about 100 centipoises and about 1,000 centipoises and may also include an antimicrobial chemical compound, a FR chemical compound, and/or oil. If oil is included in the pre-polymer, the pre-polymer contains about equal amounts of the isocyanate, the polyol, and the oil. The pre-polymer may contain between about 0.5 percent and about 5 percent of the amine catalyst, and/or the ratio of catalyst to polyol may be between about 1:20 and about 1:40. In an embodiment, the aforementioned method may be used to manufacture a bonded foam underlayment.

In still another aspect, the present invention is directed to a method for producing a polyurethane foam product by coating a plurality of foam pieces with a pre-polymer, compressing the foam pieces into a foam log of a desired density, steaming the foam log to cure the pre-polymer, wherein the pre-polymer comprises isocyanate, polyol, oil, and the DMDEE catalyst, wherein the pre-polymer contains about equal amounts of the isocyanate, the polyol, and the oil, and wherein the pre-polymer contains between about 0.5 percent and about 5 percent of the catalyst. In an embodiment, the inclusion of the catalyst reduces the cure time for the foam log by thirty percent over methods not employing the catalyst and/or reduces the amount of steam required to cure the foam log by thirty percent over methods not employing the catalyst. Variously, the foam log may be made in a continuous extruder, the foam pieces may be substantially moisture-free, the pre-polymer further comprises an antimicrobial chemical compound, and/or the pre-polymer further comprises a FR chemical compound. In other embodiments, the pre-polymer may have a viscosity between about 100 centipoises and 1,000 centipoises and/or the ratio of catalyst to polyol may be between about 1:20 and about 1:40. In yet another embodiment, the method may be used to manufacture a bonded foam underlayment.

### BRIEF DESCRIPTION OF THE DRAWINGS

For a more complete understanding of the present invention, and for further details and advantages thereof, reference is now made to the accompanying drawings, in which:

FIG. 1 is a block diagram of one embodiment of a Method for Making Bonded Foam Products;

FIG. 2 is a side view of a coating machine suitable for implementing the Method for Making Bonded Foam Products of FIG. 1;

FIG. 3 is a side view of a molding machine suitable for implementing the Method for Making Bonded Foam Products of FIG. 1;

FIG. 4 is a side view of a peeling machine suitable for implementing the Method for Making Bonded Foam Products of FIG. 1;

FIG. 5 is a side view of a continuous extruder suitable for implementing the Method for Making Bonded Foam Products of FIG. 1; and

FIG. 6 is a perspective view of a bonded floor covering underlayment which may be made by the Method for Making Bonded Foam Products of FIG. 1.

### DETAILED DESCRIPTION OF THE INVENTION

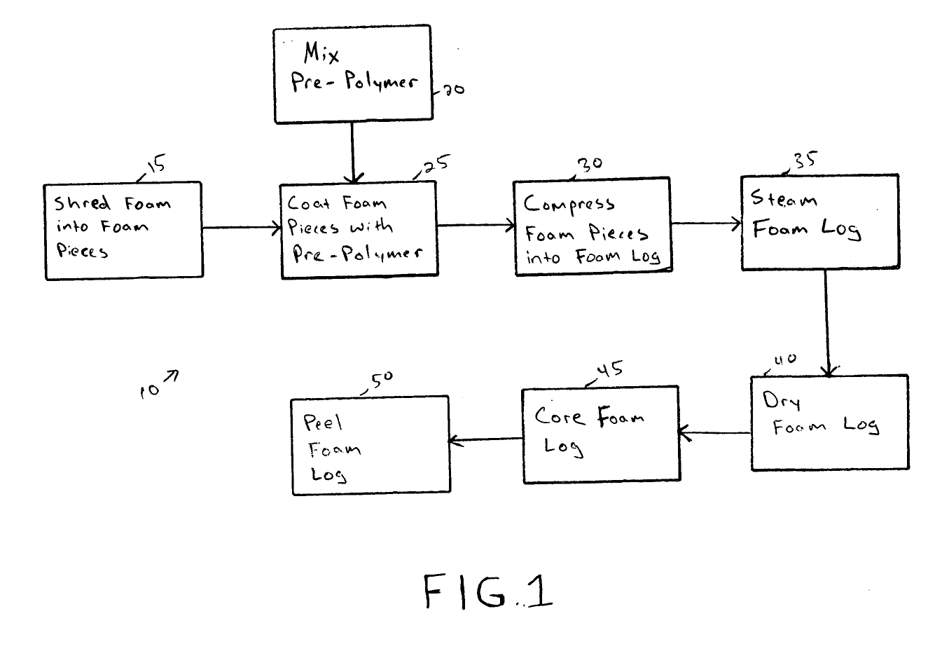

FIG. 1 depicts a block diagram of the major steps comprising one embodiment of a method 10 for making bonded foam products. The method 10 comprises: shredding foam into foam pieces at step 15, separately mixing a pre-polymer at step 20, coating the foam pieces with the pre-polymer at step 25, compressing the foam pieces into a foam log at step 30, steaming the foam log at step 35, drying the foam log at step 40, coring the foam log at step 45, and, at step 50, peeling the foam log into sheets which may be used as flooring underlayment. Each of these steps is described in greater detail below.

The Method 10 for Making Bonded Foam Products begins with foam, typically, scrap foam trimmings. The Method 10 may be performed by manufacturer of bonded foam products using scrap foam trimmings provided by a third party, for example, prime foam manufacturer, or, in the alternative, may be part of a recycling program instituted by a prime foam manufacturer or other manufacturer of foam products. Furthermore, the foam may either be new foam or recycled foam previously employed in the formation of bonded foam. The size and shape of the foam is unimportant because, as previously set forth, the foam is shredded into a plurality of smaller foam pieces in step 15 of the Method 10. Variously, it is contemplated that the foam may be polyurethane, latex, polyvinyl chloride (PVC), or any other polymeric foam of any density. It should be clearly understood, however, that the foregoing list of suitable foams is purely exemplary and it is fully contemplated that there are any number of other types of foams and/or foam compositions suitable for the uses contemplated herein.

The foam is generally free of moisture. The foam may contain an incidental amount of impurities, such as felt, fabric, fibers, leather, hair, metal, wood, plastic, and so forth. Preferably, the foam is polyurethane foam with a density similar to the desired density of the subsequently produced bonded foam product. If desired, the foam may be sorted by type and/or density prior to shredding such that foam pieces of similar composition and density are used to make a single foam log. Using foam of similar composition and density to make a single foam log produces a more uniform density throughout the foam log, and thus throughout the subsequently produced bonded foam products, for example, a bonded foam underlayment for a floor covering.

Once the foam for the foam log has been selected, the foam is placed in a shredding machine for shredding in accordance with step 15 of the Method 10. A shredding machine is a machine with a plurality of blades that cut the foam into smaller pieces of foam. The amount of time that the foam spends in the shredding machine determines the size of the shredded pieces of foam. The shredding machine may be operated periodically to provide discrete batches of shredded foam or continuously to provide a continuous supply of shredded foam. An example of a suitable shredding machine is the foam shredder manufactured by the Ormont Corporation. The foam pieces may be a geometric shape, such as round or cubic, but are generally an irregular shape due to the shredding process. The shape of the smaller foam pieces is generally unimportant because the foam will conform to the shape of the mold subsequently used by a molding machine employed to implement step 30 of the Method 10. The size of the foam pieces should be such that they are large enough to be easily handled by the various machines implementing the Method 10, yet small enough such that there is not an abundance of empty space between the foam particles. Preferably, the foam pieces are from about ¼-inch to about ¾-inch in each of length, width, and height dimensions.

While the foam is being shredded by the shredding machine at step 15, at step 20, a pre-polymer formed from a blend of plural chemical compounds is mixed in a separate process. It is contemplated that steps 15 and 20 may, as illustrated herein, be performed generally contemporaneously with one another. However, it is further contemplated that steps 15 and 20 may instead be performed at separate times. For example, shredded foam may be stored until pre-polymer is formed. The pre-polymer would then be used to coat all or part of the stored shredded foam. In the alternative, however, pre-polymer may be stored, for example, in a holding tank, until a supply of foam is shredded. The pre-polymer may then be used to coat the newly shredded foam.

A first chemical compounds forming part of the pre-polymer is isocyanate. The isocyanate reacts with the polyol (discussed below) and moisture in the steam (see step 35 of Method 10) to bind the pieces of foam together. The isocyanate used in the Method 10 for Making Bonded Foam Products may be any type of isocyanate, such as toluene diisocyanate (TDI), diisocyanatodiphenyl methane (MDI), or blends thereof. Examples of suitable isocyanates include: m-phenylene diisocyanate, p-phenylene diisocyanate, polymethylene polyphenyl-isocyanate, 2,4-toluene diisocyanate, 2,6-toluene diisocyanate, 4,4- diisocyanatodiphenyl methane, dianisidine diisocyanate, bitolylene diisocyanate, naphthalene-1,4-diisocyanate, diphenylene-4,4′-diisocyanate, xylylene-1,4-diisocyanate, xylylene-1,2-diisocyanate, xylylene-1,3 -diisocyanate, bis(4-isocyanatophenyl)-methane, bis(3-methyl-4-isocyanatophenyl)-methane, 4,4-diphenylpropane diisocyanate, isophorone diisocyanate, hexamethylene diisocyanate, methylene-bis-cyclohexylisocyanate, and mixtures thereof. Of course, it is fully contemplated that the Method 10 for Making Bonded Foam Products may include other isocyanates suitable for the uses contemplated herein. Accordingly, it should be clearly understood that the specific isocyanates disclosed herein are merely provided by way of example and that isocyanates other than those specifically disclosed herein may be suitable for the uses contemplated herein. The preferred isocyanates are RUBINATE® 9041 MDI, available from the Huntsman Corporation, or POLYMERIC MDI 199, available from the Dow Chemical Corporation. The isocyanate comprises between about 10 percent, by weight, and about 90 percent, by weight, of the total weight of the pre-polymer mixture, preferably between about 25 percent, by weight, and about 40 percent, by weight, of the total weight of the pre-polymer mixture. Most preferably, the isocyanate comprises between about 30 percent, by weight, and about 36 percent, by weight, of the total weight of the pre-polymer mixture.

A second chemical compound forming part of the pre-polymer is polyol. The polyol used in the Method 10 for Making Bonded Foam Products may be any type of polyol, such as diol, triol, tetrol, polyol, or blends thereof Examples of suitable polyols include: ethylene glycol, propylene glycol, butylene glycol, hexanediol, octanediol, neopentyl glycol, 1,4-bishydroxymethyl cyclohexane, 2-methyl-1,3-propane diol, glycerin, trimethylolethane, hexanetriol, butanetriol, quinol, polyester, methyl glucoside, triethyleneglycol, tetraethylene glycol, polyethylene glycol, dipropylene glycol, polypropylene glycol, diethylene glycol, glycerol, pentaerythritol, trimethylolpropane, sorbitol, mannitol, dibutylene glycol, polybutylene glycol, alkylene glycol, oxyalkylene glycol, ethylene glycol, diethylene glycol, dipropylene glycol, triethylene glycol, tripropylene glycol, tetraethylene glycol, tetrapropylene glycol, trimethylene glycol, tetramethylene glycol, 1,4-cyclohexanedimethanol (1,4-bis-hydroxymethylcyclohexane), and mixtures thereof. As before, the foregoing polyols are identified for purely exemplary purposes and it is fully contemplated that the Method 10 for Making Bonded Foam Products may instead include other suitable polyols not specifically disclosed herein. The preferred polyol is VORANOL® 3512A, available from the Dow Chemical Corporation. The polyol comprises between about 10 percent, by weight, and about 90 percent, by weight, of the total pre-polymer mixture, preferably between about 25 percent, by weight, and about 40 percent, by weight, of the total pre-polymer mixture. Most preferably, the polyol comprises between about 30 percent and about 36 percent, by weight, of the total pre-polymer mixture such that the polyol and isocyanate are present in the pre-polymer in approximately equal amounts.

A third chemical compound forming part of the pre-polymer is oil. The oil lowers the overall viscosity of the pre-polymer solution to facilitate better mixing and distribution of the various components of the pre-polymer. The lowered pre-polymer viscosity also allows the pre-polymer to uniformly coat the foam pieces so that improved bonding occurs. The oil may be any aromatic or non-aromatic, natural or synthetic oil. Examples of suitable oils include: naphthenic oil, soybean oil, vegetable oil, almond oil, castor oil, mineral oil, oiticica oil, anthracene oil, pine oil, synthetic oil, and mixtures thereof. Of course, the foregoing oils are identified for purely exemplary purposes purely and it is fully contemplated that the Method 10 for Making Bonded Foam Products may instead include other suitable oils not specifically disclosed herein. The preferred oil is VIPLEX® 222, available from the Crowley Chemical Company. The oil comprises between about 10 percent, by weight, and about 90 percent, by weight, of the total weight of the pre-polymer mixture, preferably between about 25 percent, by weight, and about 40 percent, by weight, of the total weight of the pre-polymer mixture. Most preferably, the oil comprises between about 30 percent, by weight, and about 36 percent, by weight, of the total weight of the pre-polymer mixture. Thus, in the most preferred embodiment the oil, polyol, and isocyanate are present in the pre-polymer in approximately equal amounts; that is each component comprises between about 30 percent, by weight, and 36 percent, by weight of the total pre-polymer.

A fourth chemical compound forming part of the pre-polymer is a catalyst. The catalyst catalyzes the curing process for the pre-polymer. The catalyst may be any amine catalyst, such as a tertiary amine catalyst. Examples of suitable tertiary amine catalysts include: triethylenediamine, tetramethylethylenediamine, bis (2-dimethylaminoethyl) ether, triethylamine, tripropylamine, tributylamine, triamylamine, pyridine, quinoline, dimethylpiperazine, piperazine, N,N-dimethylcyclohexylamine, N-ethylmorpholine, 2-methylpiperazine, N,N-dimethylethanolamine, tetramethylpropanediamine, methyltriethylenediamine, 2,4,6-tri(dimethylaminomethyl)phenol, N,N′,N″-tris(dimethylaminopropyl)-sym-hexahydrotriazine, 2-(2-dimethylaminoethoxy)ethanol, trimethylaminoethylethanolamine, dimorpholinodiethylether, N-methylimidazole, dimethylamino pyridine, dimethylethylethanolamine, and mixtures thereof. Of course, it should be clearly understood that the foregoing tertiary amine catalysts are identified for purely exemplary purposes and it should be clearly understood that the Method 10 for Making Bonded Foam Products may include catalysts other than those specifically disclosed herein. Preferably, the catalyst is DMDEE, such as the JEFFCAT® DMDEE catalyst, available from the Huntsman Corporation. The catalyst comprises between about 0.01 percent, by weight, and about 10 percent, by weight, of the total pre-polymer mixture, preferably between about 0.5 percent, by weight, and about 5 percent, by weight, of the total pre-polymer mixture. Most preferably, the catalyst comprises between about 1 percent, by weight, and about 3 percent, by weight, of the total pre-polymer mixture. Thus, the ratio of catalyst to polyol is preferably between about 1:20 and about 1:40. Because the isocyanate, polyol, and oil are preferably present in about equal amounts, the ratio of the ratio of catalyst to isocyanate is preferably between about 1:20 and about 1:40 and the ratio of catalyst to oil is also preferably between about 1:20 and about 1:40.

The pre-polymer may also contain one or more other additives which individually or collectively improve one or more characteristics of the bonded foam product. For example, the pre-polymer may contain one or more of the following types of additives: flame retardant, antimicrobial, antioxidant and color. Of the foregoing types of additives, flame retardant chemical compounds, such as melamine, expandable graphite, or dibromoneopentyl glycol, improve the flame retardant properties of the bonded foam product. Antimicrobial additives, such as zinc pyrithione, improve the antimicrobial properties of the bonded foam product. Various antioxidants, which may or may not include butylated hydroxy toluene (BHT) as an ingredient, improve the resistance of the foam to oxidative-type reactions, such as scorch resulting from high exothermic temperatures. Color additives, such as blue, green, yellow, orange, red, purple, brown, black, white, or gray colored dyes, may be used to distinguish certain bonded foam products from other bonded foam products. The aforementioned additives may alternatively or additionally be present in the scrap foam prior to the addition of the pre-polymer. Of course, it is fully contemplated that the Method 10 for Making Bonded Foam Products may include other additives for improving these or other characteristics of the bonded foam product and/or other enhancing the performance of one or more steps 15, 20, 25, 30, 35, 40, 45, and/or 50 of the Method 10. Accordingly, it should be clearly understood that the additives disclosed herein are set forth purely by way of example and it is fully contemplated that the Method 10 may also include any number of other additives not specifically recited herein.

As previously set forth, the components which collectively form the pre-polymer are combined and mixed in a mixer at step 20. It is contemplated that the mixer may either be a dynamic mixer or a static mixer. It is further contemplated that the mixer may either be a batch mixer or a continuous process mixer. Preferably, the mixer is configured to include a tank containing a motorized paddle-type mixing blade. However, it should be fully understood that other types of mixers are suitable for the uses contemplated in the Method 10 for Making Bonded Foam Products. Accordingly, the method 10 should not be limited to the specific types of mixers disclosed herein. Variously, the components which collectively form the pre-polymer may be combined generally simultaneously with one another, or, if desired, they may be added one at a time to the pre-polymer as it is being mixed. Preferably, the pre-polymer is mixed until there are about 10 percent free isocyanates available for reacting with the steam during the steaming process. The mixed pre-polymer has a viscosity between about 100 and about 1,000 centipoises, preferably between about 400 and about 600 centipoises. The pre-polymer viscosity is measured at a temperature between about 100° F. and about 110 ° F. Although the time varies depending on the composition of the pre-polymer, the pre-polymer is mixed for at least about 1 hour prior to application of the pre-polymer to the foam pieces. Preferably, the isocyanate, the polyol, and the oil are mixed together for at least about four hours. The amine catalyst would then be added to the other pre-polymer ingredients and mixed for at least about an additional two hours.

The inventive pre-polymer described herein is most suitably used for adhering polyurethane foam pieces together to form a bonded polyurethane foam product. However, the pre-polymer may be used to bond other substrates together. Examples of substrates that may be bonded together using the inventive pre-polymer include: other polymeric foams, wood, metal, glass, and plastic. It should be clearly understood, however, that other types of substrates may be bonded using the inventive pre-polymer disclosed herein. Accordingly, the Method 10 should not be limited to any particular type of substrate.

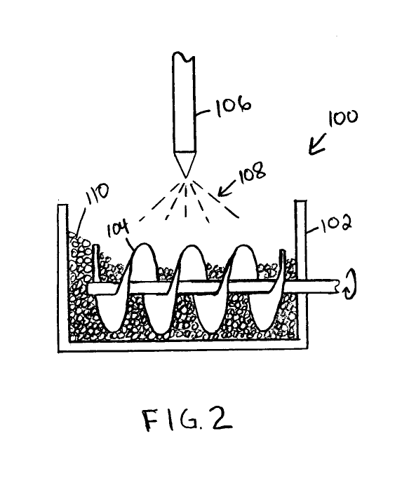

After the pre-polymer components (isocyanate, polyol, oil, catalyst, and any additives) have been suitably mixed at step 20, the pre-polymer is coated onto the shredded foam pieces at step 25. The coating machine used to coat the shredded foam pieces may be a batch or a continuous coating machine and may be oriented horizontally, vertically, or at any angle. FIG. 2 is an illustration of a suitable coating machine 100. The coating machine 100 comprises a tank 102, one or more agitators 104, and a pre-polymer applicator 106. The size and shape of the tank 102 may be varied to suit the particular application. Similarly, the number and type of agitators 104 may be varied to suit the particular application. The process of coating the foam pieces 110 begins by placing the foam pieces 110 inside the tank 102. The pre-polymer applicator 106 sprays the pre-polymer 108 onto the foam pieces 1-10. While the pre-polymer applicator 106 is spraying the foam pieces 110, the agitator 104 rotates relative to the tank 102 and moves the foam pieces 110 around within the tank 102. As the foam pieces 110 move around in the tank 102, the foam pieces 110 are substantially coated with the pre-polymer 108. The time required to substantially coat the foam pieces 110 with the pre-polymer 108 varies depending on the volume and density of the foam pieces 110, the size of the tank 102, and the number and type of agitators 104, but is generally between about 0.5 minutes and about 15 minutes. Preferably, the coating process proceeds for between about 1 minute and about 10 minutes, most preferably between about 1.5 minutes and about 2.5 minutes. Although the pre-polymer 108 is sprayed onto the foam pieces 110 in the coating process illustrated in FIG. 2, the pre-polymer may be applied to the foam pieces by other methods, such as dipping or roller coating. Thus, it is fully contemplated that the Method 10 for Making Bonded Foam Products includes other types of coating processes and should not be limited to the particular coating process disclosed herein.

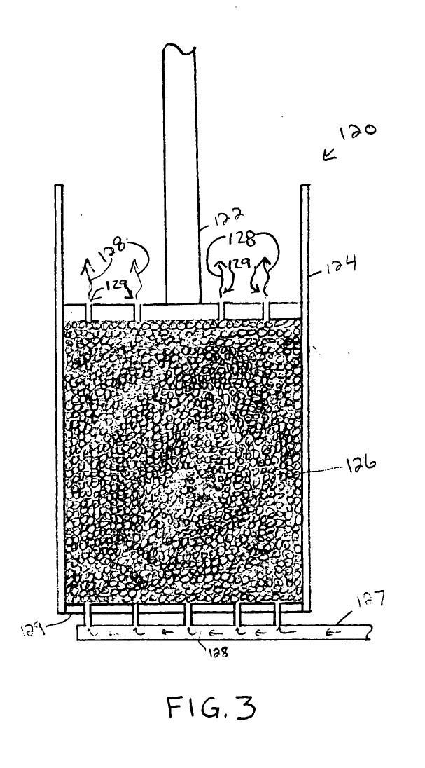

After the foam pieces have been coated with the pre-polymer at step 25, the method proceeds to step 30 where the foam pieces are transferred to a mold for compression thereof. FIG. 3 is an illustration of a typical mold 120 suitable for compressing the foam pieces. The mold 120 comprises a base 129, a generally cylindrical wall 124 detachably coupled to the base 129, a piston 122, a drive system (not shown in FIG. 3), and a steam injection system 127. Under the influence of a force exerted by the drive system, the piston 122 moves vertically with respect to the generally cylindrical wall 124 to a pre-selected position. Thus, the volume of the mold 120 defined by the piston 122, the generally cylindrical wall 124, and the base 129 is known. The piston 122 is configured to be removed from within the wall 124 and positioned away from the remainder of the mold 120 to facilitate easy loading of foam pieces into the cylindrical cavity defined by the base 129 and the generally cylindrical wall 124. Removal of the piston also facilitates the removal of a foam log after the steam process herein below described is complete by allowing the generally cylindrical wall 124 to be detached from the base 129.

When forming a foam log 126, the foam pieces are weighed before being loaded into the mold 120. After the foam pieces are loaded into the mold 120, the piston 122 compresses the foam pieces into a foam log 126. The compression ensures complete contact between the foam pieces in the foam log 126. Because the volume within the mold 120 is known and the weight of the foam pieces can be varied, the density of the foam log 126 can be selected by compressing a variable amount of foam pieces to a specific volume. For example, if the mold volume is 25 cubic feet and the desired density of the foam log is 4 pounds per cubic foot (pcf), then 100 pounds of foam are loaded in the mold 120. The weight of the foam pieces can be varied by loaded more or less foam pieces in the mold 120. The weight of the foam pieces can also be varied by changing the blend of foam pieces. In other words, the foam pieces can contain a mixture of high density foam and low density foam and the ratio of high density foam to low density foam can be varied to yield the appropriate weight of foam pieces. As an alternative method of achieving a desired density, the volume of the mold 120 can be varied for a specified weight of foam pieces. Although a batch-type mold is illustrated in FIG. 3, the foam pieces may be compressed using other compression methods, such as the continuous extruder illustrated in FIG. 5. While a specific compression process is described and illustrated with respect to FIG. 3, it should be clearly understood that the Method 10 for Making Bonded Foam Products encompasses other types of compression processes and should not be limited to the particular compression process disclosed herein.

Once the foam pieces are compressed into a foam log 126 at step 30, the method proceeds to step 35 where the foam log 126 is steamed to cure the pre-polymer. The steam injection system 127 is coupled to a steam supply (not shown) and is configured to inject steam 128 through the base 129, for example, using a pressurized flow of the steam 128. The steam 128 passes through the foam log 126 and any excess steam 128 exits through apertures 129 formed in the piston 122. An inconsequential amount of foam may pass through apertures 129 along with the excess steam 128. The moisture in the steam 128 cures the pre-polymer. The steam 128 may be any steam that is at least about 212° F. and a sufficient pressure to permeate the foam log 126. Preferably, the temperature of the steam is between about 220° F. and about the combustion temperature of the foam (about 1400° F.). The pressure of the steam is preferably between about 10 pounds per square inch gauge (psi) and about 100 psi. Most preferably, the temperature of the steam is between about 246° F. and about 256° F. and the pressure of the steam is between about 13 psi and 15 psi for a batch operation and between about 30 psi and about 45 psi for a continuous operation. The steaming time is dependent on the steam pressure and the density of the foam log. For a 4 pcf foam log and using the most preferred steam, the steam time is between about 0.5 minutes and about 3 minutes, preferably about 1.0 minutes and about 1.5 minutes. For an 8 pcf foam log and using the most preferred steam, the steam time is between about 1.5 minutes and about 5 minutes, preferably about 2 minutes and about 3 minutes. Steam times for foam logs of other densities need not be reproduced herein as such steam times can be readily interpolated or extrapolated from the foregoing steam times and other steam data. While a specific steaming process is described and illustrated with respect to FIG. 3, it should be clearly understood that the Method 10 for Making Bonded Foam Products encompasses other types of steaming processes and should not be limited to the particular steaming process disclosed herein.

After the steaming process is completed at step 35, the Method 10 proceeds to step 40 where the foam log 126 is removed from the mold 120 and allowed to dry. Here, in order to facilitate the easy unloading of the foam log 126 after the steaming process is complete, it is contemplated that the generally cylindrical wall 124 of the mold 120 is detached from the base 129 after the piston 122 is removed from within the generally cylindrical wall 124 and positioned away from the remainder of the mold 120. The required drying time is dependent on the density of the foam log 126 and the amount of moisture present in the foam log 126. Lower density foam logs 126 may be sufficiently dry to allow immediate processing. However, the foam logs 126 are generally set aside to dry for 12 to 24 hours at ambient temperature and humidity so that foam logs 126 are sufficiently dry such that the moisture in the foam log 126 does not affect any of the processing equipment downstream from the steaming process of step 35. If desired, the drying of the foam log 126 may be sped up by forcing ambient, heated, and/or dried air over or through the foam log 126. While a specific drying process is described herein, it should be clearly understood that the Method 10 for Making Bonded Foam Products encompasses other drying processes and should not be limited to the particular drying processes disclosed herein.

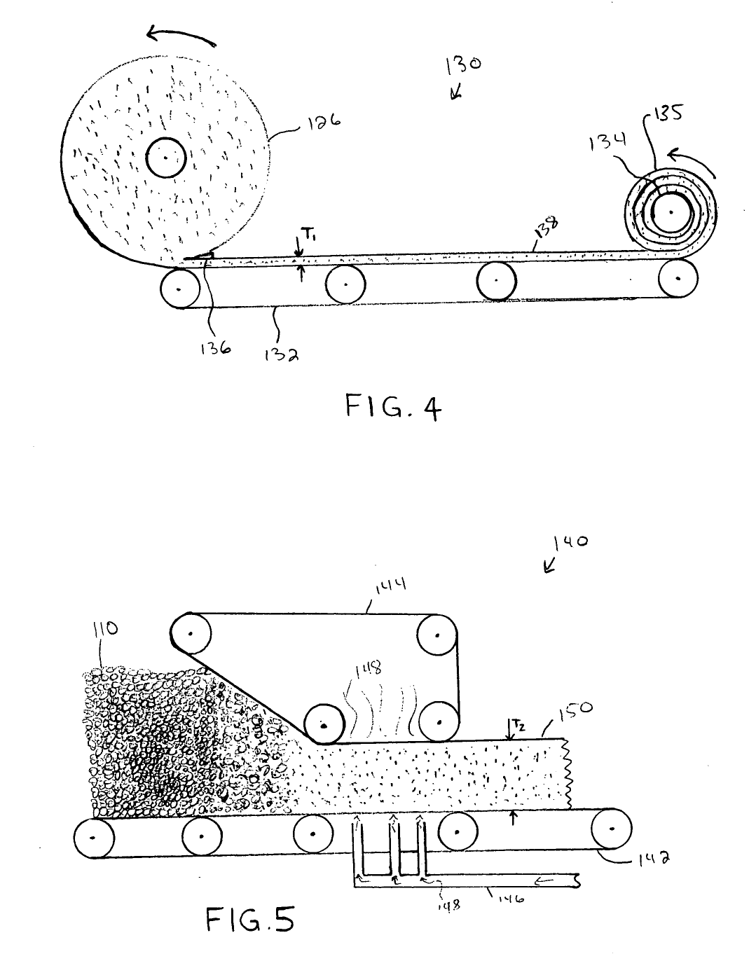

After the drying process is completed at step 40, the Method 10 proceeds to step 45 where the foam log 126 is cored by drilling an aperture through a center axis thereof. A rod is then inserted into the aperture, thereby enabling the foam log 126 to be handled without damaging the foam. The method then proceeds to step 50 where the foam log 126 is transported to a suitably configured peeling machine, such peeling machine 130 illustrated in FIG. 4, for commencement of a peeling process herein below described.

As may be seen in FIG. 4, the peeling machine 130 comprises a blade 136, a conveyor 132, and a take-up roll 134. The foam log 126 is rotated against the blade 136 such that the blade peels off a length of a bonded foam product 138 having a desired thickness, T₁, and formed from the bonded foam of the foam log 126. The bonded foam product 138 peeled off of the foam log 126 is uniformly thick. As disclosed herein, the bonded foam is continuously peeled off of the foam log 126 at a constant speed. Likewise, the foam log 126 is continuously lowered with respect to the blade 136 at a constant speed. As a result, that the blade 136 constantly peels off a thickness T₁ of foam from the foam log 126. In other words, as the diameter of the foam log 126 is reduced, the foam log 126 is lowered so that the bonded foam product 138 has a uniform thickness.

It is contemplated that the bonded foam product 138 formed in the foregoing manner will have a variety of applications, a number of which are not specifically recited herein. One particularly desirable application is the employment of the bonded foam product 138 as a flooring underlayment. A variety of characteristics make the bonded foam product 138 well suited for use as a flooring underlayment, among them, the formation of the bonded foam product 138 in an “endless” length of uniform thickness suitable for rolling. As the length of bonded foam product 138 is transported towards the take-up roll 134 the bonded foam product 138 may also be trimmed to a uniform width, particularly if, after peeling, the bonded foam product 138 is wider than the width desired for the selected application. The bonded foam product 138 continues to travel along the conveyor 132 and is collected on the take-up roll 134, thereby forming roll 135 of the bonded foam product 138. When the roll 135 is of a desired diameter, the bonded foam product 138 is cut along its widthwise dimension to sever the roll 135 from the “endless” length of the bonded foam product 138 which continues to be peeled form the continuing being peeled from the foam log 126. The roll 135 is now ready for transport to distributors, wholesalers, retailers and the like. If desired, the bonded foam product 138 may be cut up into different lengths. For example, the bonded foam product 138 may be cut to a shorter length so that the roll 135 is lighter and easier to handle.

As an alternative to the batch compressing and steaming process described above, the present invention may be utilized in a continuous compressing and molding process. FIG. 5 illustrates a continuous extruder 140 used for continuously compressing and steaming the foam pieces 110 into a continuous foam log 150. The continuous extruder 140 comprises an upper conveyor 144, a lower conveyor 142, and a steam injection system 146. The process of compressing and steaming the foam log 150 begins with the placement of foam pieces 110 onto the lower conveyor 142. Because the density of the foam log 150 produced by the continuous extruder 140 depends on the mass flow rate of the foam pieces 110 through the continuous extruder 140 as well as the volumetric flow rate of the foam log 150 exiting the extruder, the weight of the foam pieces 110 is typically measured prior to placing the foam pieces 110 onto the lower conveyor 142. As the foam pieces 110 travel through the continuous extruder 140, the foam pieces 110 are compressed by the upper conveyor 144. Because the upper conveyor 144 and the lower conveyor 142 travel in the same direction and the foam pieces 110 are continuously entering the continuous extruder 140, the foam pieces 110 are compressed by the downward traveling upper conveyor 144. The height of the upper conveyor 144 over the lower conveyor 142 is adjustable and the density of the foam log 150 can be adjusted by raising and lowering the upper conveyor 142 relative to the lower conveyor 142.

When the foam log is at a desired density, steam 148 is injected into the underside of the foam log 150 through perforations in the lower conveyor 142, with any excess steam passing through the perforations in the upper conveyor 144. The continuous extruder 140 is configured such that the residence time of the foam log 150 in the steaming area of the continuous extruder 140 is equal to the steaming time required in the batch process. Thus, by using an amine catalyst, such as DMDEE, in the pre-polymer to reduce the steam time by at least about 30 percent, the throughput rate of the continuous extruder 140 can be increased by between about 40 percent and about 50 percent. The foam log produced by the continuous extruder 140 is generally rectangular in cross section and, as a result, is typically sliced into sheets rather than peeled in the manner described above.

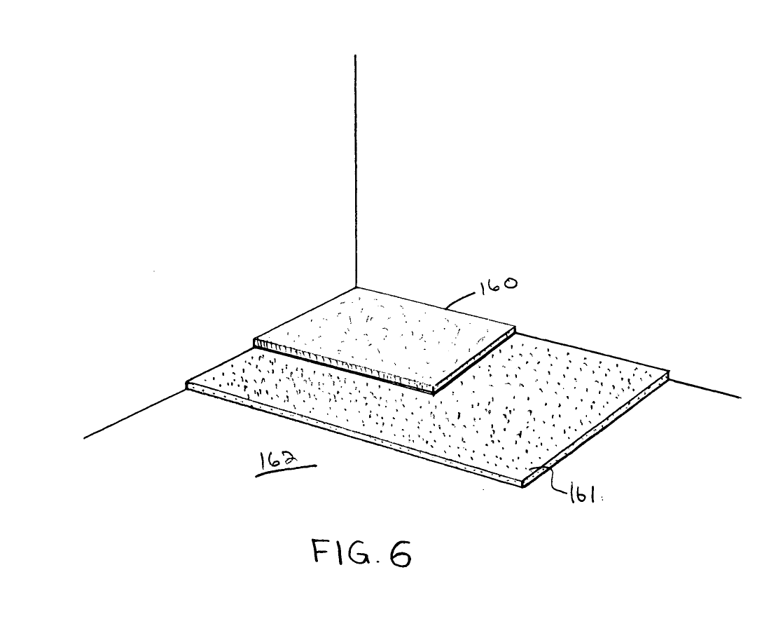

FIG. 6 illustrates the application of the roll 135 of the bonded foam product 138 as a flooring underlayment 161 to be installed between a subfloor 162 and a flooring product 160. Typically, the flooring underlayment 161 would be rolled onto the subfloor, cut to size and then covered with the flooring product 160. Of course, the foregoing process would typically include the steps of joining of adjoining sections of flooring underlayment, if necessary, and adhering of the flooring underlayment 161 to the subfloor 162 and/or the flooring 160. The foregoing steps have been omitted, however, purely for ease of description. The flooring underlayment 161 cushions the flooring product 160, smoothes out imperfections in the subfloor 162, reduces sound reflection between the flooring product 160 and the subfloor 162, and if the flooring underlayment 161 is configured with a moisture barrier, the flooring underlayment 161 discourages the transmission of moisture between the subfloor 162 and the flooring product 160. The most common use for a flooring underlayment 161 formed from bonded foam is as a carpet pad. Thus it is within the scope of the invention that the flooring product 160 is carpet. However, it is fully contemplated that the flooring underlayment 161 can be used in conjunction with a variety of other flooring products 160. Examples of other flooring products 160 are: wood flooring, laminate flooring, tile flooring, tile adhered to laminate flooring, vinyl flooring, and linoleum flooring. The Method 10 for Making Bonded Foam Products includes use of the bonded foam product as an underlayment for other flooring products and should not be limited to the specific flooring products disclosed herein.

### EXAMPLE ONE

Two experiments were conducted to confirm the advantageous use of amine catalysts, such as DMDEE, in the Method 10 for Making Bonded Foam Products. The first experiment was the production of 4 pcf bonded foam logs produced using the above-described batch Method 10 for Making Bonded Foam Products. Three different formulations of pre-polymer were prepared for the first experiment. Table 1 below illustrates the pre-polymer formulations used to produce the pre-polymer (1) for the control group, (2) using RUBINATE® 9041 MDI, and (3) using POLYMERIC MDI 199:

TABLE 1

| | Batch #1 | Batch #2 | Batch #3 |
|---|---|---|---|
| Pre-polymer Component | (percent) | (percent) | (percent) |
| POLYMERIC MDI 199 | 37 | None | 37 |
| RUBINATE 9041 MDI | None | 37 | None |
| VORANOL 3512A Polyol | 28 | 28 | 28 |
| VIPLEX 222 Oil | 35 | 35 | 35 |
| JEFFCAT DMDEE Catalyst | None | 1 | 1 |

All values listed in Table 1 are in parts by weight (percent). The three pre-polymers were prepared by mixing the MDI, polyol, and oil for approximately 18 hours. The free isocyanate percentage at that point was 10.7 by weight. The DMDEE catalyst was then added to the MDI, polyol, and oil and the pre-polymer was mixed for an additional 2 hours. The finished pre-polymer was then coated on shredded foam as follows: 46 pounds of pre-polymer to a mixture of 275 pounds of ether scrap foam and 155 pounds of reclaim scrap foam. Thirteen logs were produced from the mixture, of which twelve were useable. Table 2 below describes the results of the experimental runs:

TABLE 2

| Log | Pre-polymer | Steam Time | |
|---|---|---|---|
| No. | Used | (minutes) | Observations |
| 1A | Batch 1 | 3.0 | Looked good & felt good |
| 1B | Batch 1 | 2.5 | Looked good & felt good |
| 1C | Batch 1 | 2.0 | Looked good & felt good |
| 1D | Batch 1 | 1.5 | Looked good, some ‘crunchiness’ |
| | | | at top of log |
| 1E | Batch 1 | 1.0 | Fell apart at demold; unusable |
| 2A | Batch 2 | 3.0 | Did not produce to conserve |
| | | | resources |
| 2B | Batch 2 | 2.5 | Looked good & felt good |
| 2C | Batch 2 | 2.0 | Looked good & felt good |
| 2D | Batch 2 | 1.5 | Looked good, some ‘crunchiness’ |
| | | | at top of log |
| 2E | Batch 2 | 1.0 | Looked good, some ‘crunchiness’ |
| | | | at top of log |
| 3A | Batch 3 | 3.0 | Did not produce to conserve |
| | | | resources |
| 3B | Batch 3 | 2.5 | Looked good & felt good |
| 3C | Batch 3 | 2.0 | Looked good & felt good |
| 3D | Batch 3 | 1.5 | Looked good, some ‘crunchiness’ |
| | | | at top of log |
| 3E | Batch 3 | 1.0 | Looked good, poor tensile at top |
| | | | (could pull out handfuls of foam |
| | | | scrap) |

The twelve usable logs were peeled to a thickness of ½-inch and a 9-foot by 6.5-foot product sample was taken from the outer surface of each log. A total of nine test samples were cut from each product sample, the test samples each being 2-foot by 2-foot squares. Thus, a total of 108 test samples were sent to a laboratory for testing.

The laboratory tested the test samples for compression sets, compression force deflection, tensile strength, elongation, tear die C, and density. The compression sets were tested at 50 percent in accordance with ASTM D-3574D-95. The compression force deflection was tested at 65 percent in accordance with ASTM D-3574C-95. The tensile strength and elongation were tested in accordance with ASTM D-3574E-95. The tear die C was tested in accordance with ASTM D-624-91. Finally, the density was tested in accordance with ASTM D-3574A-95. The results of these tests are illustrated in Tables 3, 4, 5, 6, 7, and 8 below. In Tables 3, 4, 5, 6, 7, and 8, the individual sample values are given along with the average to illustrate the variance of each sample.

TABLE 3

| Steam | | | | | | |
|---|---|---|---|---|---|---|
| Time | Batch 1 | | Batch 2 | | Batch 3 | |
| (min- | Compression Set | | Compression Set | | Compression Set | |
| utes) | @ 50% (%) | | @ 50% (%) | | @ 50% (%) | |
| 3.0 | 1A1 | 16.1 | Not Produced | | Not Produced | |
| | 1A2 | 15.5 | | | | |
| | 1A3 | 16.1 | | | | |
| | 1A4 | 16.9 | | | | |
| | 1A5 | 13.8 | | | | |
| | 1A6 | 15.9 | | | | |
| | 1A7 | 15.0 | | | | |
| | 1A8 | 14.3 | | | | |
| | 1A9 | 14.2 | | | | |
| | AVERAGE | 15.3 | | | | |
| 2.5 | 1B1 | 15.1 | 2B1 | 18.7 | 3B1 | 16.2 |
| | 1B2 | 15.8 | 2B2 | 18.5 | 3B2 | 17.6 |
| | 1B3 | 16.1 | 2B3 | 18.3 | 3B3 | 16.9 |
| | 1B4 | 16.3 | 2B4 | 17.2 | 3B4 | 17.4 |
| | 1B5 | 14.4 | 2B5 | 18.7 | 3B5 | 16.2 |
| | 1B6 | 15.8 | 2B6 | 19.3 | 3B6 | 15.2 |
| | 1B7 | 16.5 | 2B7 | 17.3 | 3B7 | 16.8 |
| | 1B8 | 16.8 | 2B8 | 16.1 | 3B8 | 15.9 |
| | 1B9 | 16.0 | 2B9 | 17.6 | 3B9 | 16.4 |
| | AVERAGE | 15.9 | AVERAGE | 18.0 | AVERAGE | 16.5 |
| 2.0 | 1C1 | 19.4 | 2C1 | 14.2 | 3C1 | 20.0 |
| | 1C2 | 16.8 | 2C2 | 14.7 | 3C2 | 18.8 |
| | 1C3 | 18.1 | 2C3 | 14.7 | 3C3 | 21.2 |
| | 1C4 | 19.7 | 2C4 | 15.7 | 3C4 | 18.6 |
| | 1C5 | 18.3 | 2C5 | 16.1 | 3C5 | 19.8 |
| | 1C6 | 17.4 | 2C6 | 18.5 | 3C6 | 16.3 |
| | 1C7 | 18.0 | 2C7 | 15.1 | 3C7 | 18.5 |
| | 1C8 | 17.5 | 2C8 | 15.0 | 3C8 | 16.7 |
| | 1C9 | 17.0 | 2C9 | 15.7 | 3C9 | 19.2 |
| | AVERAGE | 18.0 | AVERAGE | 15.5 | AVERAGE | 18.8 |
| 1.5 | 1D1 | 16.6 | 2D1 | 15.4 | 3D1 | 19.9 |
| | 1D2 | 18.2 | 2D2 | 14.9 | 3D2 | 18.2 |
| | 1D3 | 16.9 | 2D3 | 14.3 | 3D3 | 18.9 |
| | 1D4 | 16.6 | 2D4 | 15.9 | 3D4 | 22.3 |
| | 1D5 | 18.1 | 2D5 | 17.2 | 3D5 | 22.0 |
| | 1D6 | 16.0 | 2D6 | 15.1 | 3D6 | 18.6 |
| | 1D7 | 16.6 | 2D7 | 14.9 | 3D7 | 26.5 |
| | 1D8 | 17.8 | 2D8 | 16.1 | 3D8 | 21.9 |
| | 1D9 | 16.6 | 2D9 | 15.0 | 3D9 | 20.6 |
| | AVERAGE | 17.0 | AVERAGE | 15.4 | AVERAGE | 21.0 |

| | | | | | |
|---|---|---|---|---|---|
| 1.0 | Not Produced | 2E1 | 18.2 | 3E1 | 18.0 |
| | | 2E2 | 18.9 | 3E2 | 19.0 |
| | | 2E3 | 16.7 | 3E3 | 18.9 |
| | | 2E4 | 14.8 | 3E4 | 17.2 |
| | | 2E5 | 15.8 | 3E5 | 16.8 |
| | | 2E6 | 15.9 | 3E6 | 18.0 |
| | | 2E7 | 16.0 | 3E7 | 17.8 |
| | | 2E8 | 17.0 | 3E8 | 13.1 |
| | | 2E9 | 15.1 | 3E9 | 16.3 |
| | | AVERAGE | 16.5 | AVERAGE | 17.2 |

TABLE 4

| Steam | | | | | | |
|---|---|---|---|---|---|---|
| Time | Batch 1 | | Batch 2 | | Batch 3 | |
| (min- | CFD @ 65% | | CFD @ 65% | | CFD @ 65% | |
| utes) | (%) | | (%) | | (%) | |
| 3.0 | 1A1 | 6.2 | Not Produced | | Not Produced | |
| | 1A2 | 7.5 | | | | |
| | 1A3 | 7.0 | | | | |
| | 1A4 | 6.6 | | | | |
| | 1A5 | 6.7 | | | | |
| | 1A6 | 9.2 | | | | |
| | 1A7 | 7.3 | | | | |
| | 1A8 | 8.2 | | | | |
| | 1A9 | 9.4 | | | | |
| | AVERAGE | 7.6 | | | | |
| 2.5 | 1B1 | 9.8 | 2B1 | 8.1 | 3B1 | 9.1 |
| | 1B2 | 9.1 | 2B2 | 7.3 | 3B2 | 6.6 |
| | 1B3 | 7.2 | 2B3 | 10.2 | 3B3 | 7.9 |
| | 1B4 | 9.1 | 2B4 | 7.1 | 3B4 | 8.3 |
| | 1B5 | 9.0 | 2B5 | 6.4 | 3B5 | 7.6 |
| | 1B6 | 7.7 | 2B6 | 7.1 | 3B6 | 7.7 |
| | 1B7 | 6.4 | 2B7 | 8.8 | 3B7 | 7.9 |
| | 1B8 | 9.3 | 2B8 | 7.6 | 3B8 | 10.3 |
| | 1B9 | 6.2 | 2B9 | 11.0 | 3B9 | 9.5 |
| | AVERAGE | 8.2 | AVERAGE | 8.2 | AVERAGE | 8.3 |
| 2.0 | 1C1 | 6.6 | 2C1 | 10.9 | 3C1 | 9.9 |
| | 1C2 | 7.7 | 2C2 | 11.2 | 3C2 | 7.3 |
| | 1C3 | 7.2 | 2C3 | 9.7 | 3C3 | 7.8 |
| | 1C4 | 6.9 | 2C4 | 8.7 | 3C4 | 8.3 |
| | 1C5 | 8.0 | 2C5 | 7.2 | 3C5 | 7.6 |
| | 1C6 | 7.2 | 2C6 | 8.9 | 3C6 | 7.4 |
| | 1C7 | 7.7 | 2C7 | 6.6 | 3C7 | 9.9 |
| | 1C8 | 6.9 | 2C8 | 7.3 | 3C8 | 10.1 |
| | 1C9 | 10.2 | 2C9 | 8.4 | 3C9 | 11.1 |
| | AVERAGE | 7.6 | AVERAGE | 8.8 | AVERAGE | 8.8 |
| 1.5 | 1D1 | 7.6 | 2D1 | 7.5 | 3D1 | 8.7 |
| | 1D2 | 8.2 | 2D2 | 7.1 | 3D2 | 9.8 |
| | 1D3 | 10.8 | 2D3 | 9.1 | 3D3 | 8.9 |
| | 1D4 | 7.4 | 2D4 | 7.2 | 3D4 | 9.9 |
| | 1D5 | 8.8 | 2D5 | 10.0 | 3D5 | 7.9 |
| | 1D6 | 9.7 | 2D6 | 9.4 | 3D6 | 7.5 |
| | 1D7 | 6.8 | 2D7 | 8.8 | 3D7 | 7.8 |
| | 1D8 | 7.9 | 2D8 | 6.9 | 3D8 | 6.6 |
| | 1D9 | 6.7 | 2D9 | 10.2 | 3D9 | 6.8 |
| | AVERAGE | 8.2 | AVERAGE | 8.5 | AVERAGE | 8.2 |

| | | | | | |
|---|---|---|---|---|---|
| 1.0 | Not Produced | 2E1 | 8.4 | 3E1 | 9.9 |
| | | 2E2 | 11.4 | 3E2 | 10.7 |
| | | 2E3 | 8.8 | 3E3 | 7.6 |
| | | 2E4 | 10.1 | 3E4 | 7.9 |
| | | 2E5 | 9.1 | 3E5 | 9.5 |
| | | 2E6 | 8.5 | 3E6 | 8.7 |
| | | 2E7 | 10.6 | 3E7 | 9.8 |
| | | 2E8 | 9.2 | 3E8 | 9.6 |
| | | 2E9 | 8.7 | 3E9 | 10.0 |
| | | AVERAGE | 9.4 | AVERAGE | 9.3 |

TABLE 5

| Steam | | | | | | |
|---|---|---|---|---|---|---|
| Time | Batch 1 | | Batch 2 | | Batch 3 | |
| (min- | Tear Die C | | Tear Die C | | Tear Die C | |
| utes) | (N/m) | | (N/m) | | (N/m) | |
| 3.0 | 1A1 | 302 | Not Produced | | Not Produced | |
| | 1A2 | 281 | | | | |
| | 1A3 | 235 | | | | |
| | 1A4 | 362 | | | | |
| | 1A5 | 364 | | | | |
| | 1A6 | 304 | | | | |
| | 1A7 | 398 | | | | |
| | 1A8 | 370 | | | | |
| | 1A9 | 393 | | | | |
| | AVERAGE | 334 | | | | |
| 2.5 | 1B1 | 311 | 2B1 | 250 | 3B1 | 269 |
| | 1B2 | 392 | 2B2 | 212 | 3B2 | 369 |
| | 1B3 | 350 | 2B3 | 210 | 3B3 | 323 |
| | 1B4 | 269 | 2B4 | 246 | 3B4 | 276 |
| | 1B5 | 326 | 2B5 | 298 | 3B5 | 429 |
| | 1B6 | 322 | 2B6 | 235 | 3B6 | 433 |
| | 1B7 | 342 | 2B7 | 323 | 3B7 | 364 |
| | 1B8 | 392 | 2B8 | 342 | 3B8 | 396 |
| | 1B9 | 370 | 2B9 | 358 | 3B9 | 435 |
| | AVERAGE | 342 | AVERAGE | 275 | AVERAGE | 366 |
| 2.0 | 1C1 | 260 | 2C1 | 378 | 3C1 | 400 |
| | 1C2 | 349 | 2C2 | 331 | 3C2 | 375 |
| | 1C3 | 289 | 2C3 | 334 | 3C3 | 506 |
| | 1C4 | 309 | 2C4 | 303 | 3C4 | 401 |
| | 1C5 | 302 | 2C5 | 398 | 3C5 | 432 |
| | 1C6 | 233 | 2C6 | 285 | 3C6 | 410 |
| | 1C7 | 383 | 2C7 | 278 | 3C7 | 451 |
| | 1C8 | 356 | 2C8 | 277 | 3C8 | 496 |
| | 1C9 | 329 | 2C9 | 304 | 3C9 | 409 |
| | AVERAGE | 312 | AVERAGE | 321 | AVERAGE | 431 |
| 1.5 | 1D1 | 423 | 2D1 | 345 | 3D1 | 444 |
| | 1D2 | 330 | 2D2 | 317 | 3D2 | 432 |
| | 1D3 | 338 | 2D3 | 343 | 3D3 | 381 |
| | 1D4 | 277 | 2D4 | 495 | 3D4 | 390 |
| | 1D5 | 278 | 2D5 | 256 | 3D5 | 428 |
| | 1D6 | 315 | 2D6 | 390 | 3D6 | 444 |
| | 1D7 | 254 | 2D7 | 351 | 3D7 | 376 |
| | 1D8 | 322 | 2D8 | 306 | 3D8 | 293 |
| | 1D9 | 282 | 2D9 | 341 | 3D9 | 346 |
| | AVERAGE | 313 | AVERAGE | 349 | AVERAGE | 393 |

| | | | | | |
|---|---|---|---|---|---|
| 1.0 | Not Produced | 2E1 | 375 | 3E1 | 333 |
| | | 2E2 | 320 | 3E2 | 326 |
| | | 2E3 | 358 | 3E3 | 266 |
| | | 2E4 | 351 | 3E4 | 378 |
| | | 2E5 | 282 | 3E5 | 332 |
| | | 2E6 | 315 | 3E6 | 393 |
| | | 2E7 | 401 | 3E7 | 359 |
| | | 2E8 | 425 | 3E8 | 377 |
| | | 2E9 | 457 | 3E9 | 409 |
| | | AVERAGE | 365 | AVERAGE | 353 |

TABLE 6

| Steam | Batch 1 | | Batch 2 | | Batch 3 | |
|---|---|---|---|---|---|---|
| Time | Tensile Strength | | Tensile Strength | | Tensile Strength | |
| (minutes) | (psi) | | (psi) | | (psi) | |
| 3.0 | 1A1 | 2.3 | Not Produced | | Not Produced | |
| | 1A2 | 3.3 | | | | |
| | 1A3 | 2.5 | | | | |
| | 1A4 | 3.0 | | | | |
| | 1A5 | 3.4 | | | | |
| | 1A6 | 3.7 | | | | |
| | 1A7 | 4.2 | | | | |
| | 1A8 | 3.8 | | | | |
| | 1A9 | 4.4 | | | | |
| | AVERAGE | 3.4 | | | | |
| 2.5 | 1B1 | 4.1 | 2B1 | 2.8 | 3B1 | 3.8 |
| | 1B2 | 4.2 | 2B2 | 2.6 | 3B2 | 3.4 |
| | 1B3 | 4.3 | 2B3 | 2.2 | 3B3 | 3.9 |
| | 1B4 | 4.5 | 2B4 | 2.1 | 3B4 | 4.2 |
| | 1B5 | 3.3 | 2B5 | 2.8 | 3B5 | 4.2 |
| | 1B6 | 3.6 | 2B6 | 2.7 | 3B6 | 5.7 |
| | 1B7 | 4.0 | 2B7 | 3.1 | 3B7 | 3.9 |
| | 1B8 | 3.5 | 2B8 | 3.4 | 3B8 | 5.5 |
| | 1B9 | 4.0 | 2B9 | 3.3 | 3B9 | 4.8 |
| | AVERAGE | 3.9 | AVERAGE | 2.8 | AVERAGE | 4.4 |
| 2.0 | 1C1 | 3.3 | 2C1 | 3.6 | 3C1 | 4.4 |
| | 1C2 | 3.5 | 2C2 | 3.6 | 3C2 | 4.2 |
| | 1C3 | 2.3 | 2C3 | 3.4 | 3C3 | 4.1 |
| | 1C4 | 4.9 | 2C4 | 3.1 | 3C4 | 4.1 |
| | 1C5 | 3.6 | 2C5 | 3.1 | 3C5 | 5.2 |
| | 1C6 | 3.0 | 2C6 | 4.0 | 3C6 | 4.1 |
| | 1C7 | 3.2 | 2C7 | 4.1 | 3C7 | 6.0 |
| | 1C8 | 4.3 | 2C8 | 3.7 | 3C8 | 5.0 |
| | 1C9 | 4.0 | 2C9 | 4.1 | 3C9 | 4.9 |
| | AVERAGE | 3.6 | AVERAGE | 3.6 | AVERAGE | 4.7 |
| 1.5 | 1D1 | 4.3 | 2D1 | 3.9 | 3D1 | 6.0 |
| | 1D2 | 3.9 | 2D2 | 4.6 | 3D2 | 4.7 |
| | 1D3 | 3.5 | 2D3 | 3.1 | 3D3 | 4.3 |
| | 1D4 | 3.9 | 2D4 | 4.4 | 3D4 | 3.4 |
| | 1D5 | 3.9 | 2D5 | 5.3 | 3D5 | 4.3 |
| | 1D6 | 3.6 | 2D6 | 5.2 | 3D6 | 3.9 |
| | 1D7 | 2.7 | 2D7 | 3.4 | 3D7 | 5.2 |
| | 1D8 | 3.1 | 2D8 | 3.3 | 3D8 | 5.0 |
| | 1D9 | 3.3 | 2D9 | 3.8 | 3D9 | 4.5 |
| | AVERAGE | 3.6 | AVERAGE | 4.1 | AVERAGE | 4.6 |

| | | | | | |
|---|---|---|---|---|---|
| 1.0 | Not Produced | 2E1 | 3.5 | 3E1 | 3.6 |
| | | 2E2 | 3.8 | 3E2 | 4.1 |
| | | 2E3 | 3.2 | 3E3 | 2.9 |
| | | 2E4 | 3.5 | 3E4 | 3.5 |
| | | 2E5 | 3.9 | 3E5 | 2.8 |
| | | 2E6 | 4.2 | 3E6 | 3.7 |
| | | 2E7 | 5.1 | 3E7 | 6.1 |
| | | 2E8 | 6.0 | 3E8 | 5.4 |
| | | 2E9 | 5.0 | 3E9 | 4.9 |
| | | AVERAGE | 4.2 | AVERAGE | 4.1 |

TABLE 7

| Steam Time | Batch 1 | | Batch 2 | | Batch 3 | |
|---|---|---|---|---|---|---|
| (minutes) | Elongation (%) | | Elongation (%) | | Elongation (%) | |
| 3.0 | 1A1 | 38 | Not Produced | | Not Produced | |
| | 1A2 | 55 | | | | |
| | 1A3 | 38 | | | | |
| | 1A4 | 60 | | | | |
| | 1A5 | 55 | | | | |
| | 1A6 | 42 | | | | |
| | 1A7 | 47 | | | | |
| | 1A8 | 38 | | | | |
| | 1A9 | 52 | | | | |
| | AVERAGE | 47 | | | | |
| 2.5 | 1B1 | 45 | 2B1 | 63 | 3B1 | 50 |
| | 1B2 | 52 | 2B2 | 55 | 3B2 | 43 |
| | 1B3 | 53 | 2B3 | 53 | 3B3 | 58 |
| | 1B4 | 63 | 2B4 | 50 | 3B4 | 57 |
| | 1B5 | 53 | 2B5 | 68 | 3B5 | 55 |
| | 1B6 | 47 | 2B6 | 68 | 3B6 | 68 |
| | 1B7 | 57 | 2B7 | 63 | 3B7 | 48 |
| | 1B8 | 65 | 2B8 | 63 | 3B8 | 53 |
| | 1B9 | 60 | 2B9 | 55 | 3B9 | 55 |
| | AVERAGE | 55 | AVERAGE | 60 | AVERAGE | 54 |
| 2.0 | 1C1 | 52 | 2C1 | 55 | 3C1 | 65 |
| | 1C2 | 72 | 2C2 | 48 | 3C2 | 62 |
| | 1C3 | 45 | 2C3 | 58 | 3C3 | 62 |
| | 1C4 | 68 | 2C4 | 45 | 3C4 | 47 |
| | 1C5 | 52 | 2C5 | 40 | 3C5 | 75 |
| | 1C6 | 53 | 2C6 | 60 | 3C6 | 48 |
| | 1C7 | 50 | 2C7 | 48 | 3C7 | 60 |
| | 1C8 | 53 | 2C8 | 43 | 3C8 | 57 |
| | 1C9 | 53 | 2C9 | 45 | 3C9 | 52 |
| | AVERAGE | 55 | AVERAGE | 49 | AVERAGE | 59 |
| 1.5 | 1D1 | 70 | 2D1 | 50 | 3D1 | 70 |
| | 1D2 | 43 | 2D2 | 50 | 3D2 | 63 |
| | 1D3 | 42 | 2D3 | 57 | 3D3 | 57 |
| | 1D4 | 57 | 2D4 | 65 | 3D4 | 57 |
| | 1D5 | 53 | 2D5 | 58 | 3D5 | 55 |
| | 1D6 | 48 | 2D6 | 65 | 3D6 | 55 |
| | 1D7 | 58 | 2D7 | 45 | 3D7 | 78 |
| | 1D8 | 53 | 2D8 | 52 | 3D8 | 70 |
| | 1D9 | 52 | 2D9 | 48 | 3D9 | 63 |
| | AVERAGE | 53 | AVERAGE | 54 | AVERAGE | 63 |

| | | | | | |
|---|---|---|---|---|---|
| 1.0 | Not Produced | 2E1 | 50 | 3E1 | 47 |
| | | 2E2 | 42 | 3E2 | 50 |
| | | 2E3 | 48 | 3E3 | 38 |
| | | 2E4 | 38 | 3E4 | 52 |
| | | 2E5 | 52 | 3E5 | 52 |
| | | 2E6 | 55 | 3E6 | 40 |
| | | 2E7 | 55 | 3E7 | 55 |
| | | 2E8 | 63 | 3E8 | 57 |
| | | 2E9 | 55 | 3E9 | 57 |
| | | AVERAGE | 51 | AVERAGE | 50 |

TABLE 8

| Steam Time | Batch 1 | | Batch 2 | | Batch 3 | |
|---|---|---|---|---|---|---|
| (minutes) | Density (pcf) | | Density (pcf) | | Density (pcf) | |
| 3.0 | 1A1 | 2.7 | Not Produced | | Not Produced | |
| | 1A2 | 3.0 | | | | |
| | 1A3 | 3.2 | | | | |
| | 1A4 | 3.5 | | | | |
| | 1A5 | 2.9 | | | | |
| | 1A6 | 4.0 | | | | |
| | 1A7 | 3.8 | | | | |
| | 1A8 | 3.3 | | | | |
| | 1A9 | 4.0 | | | | |
| | AVERAGE | 3.4 | | | | |
| 2.5 | 1B1 | 3.7 | 2B1 | 3.5 | 3B1 | 3.5 |
| | 1B2 | 3.5 | 2B2 | 3.0 | 3B2 | 3.3 |
| | 1B3 | 3.3 | 2B3 | 3.7 | 3B3 | 3.2 |
| | 1B4 | 3.4 | 2B4 | 3.2 | 3B4 | 3.2 |
| | 1B5 | 3.4 | 2B5 | 2.9 | 3B5 | 3.2 |
| | 1B6 | 3.0 | 2B6 | 3.2 | 3B6 | 3.0 |
| | 1B7 | 3.0 | 2B7 | 4.0 | 3B7 | 3.2 |
| | 1B8 | 3.0 | 2B8 | 3.1 | 3B8 | 3.6 |
| | 1B9 | 3.0 | 2B9 | 4.1 | 3B9 | 3.4 |
| | AVERAGE | 3.3 | AVERAGE | 3.4 | AVERAGE | 3.3 |
| 2.0 | 1C1 | 2.8 | 2C1 | 3.6 | 3C1 | 3.6 |
| | 1C2 | 3.4 | 2C2 | 3.8 | 3C2 | 2.8 |
| | 1C3 | 3.0 | 2C3 | 3.9 | 3C3 | 3.0 |
| | 1C4 | 2.7 | 2C4 | 3.3 | 3C4 | 3.2 |
| | 1C5 | 2.8 | 2C5 | 3.0 | 3C5 | 3.1 |
| | 1C6 | 3.5 | 2C6 | 3.5 | 3C6 | 3.0 |
| | 1C7 | 3.2 | 2C7 | 3.1 | 3C7 | 3.6 |
| | 1C8 | 3.2 | 2C8 | 3.0 | 3C8 | 3.5 |
| | 1C9 | 4.0 | 2C9 | 3.1 | 3C9 | 3.9 |
| | AVERAGE | 3.2 | AVERAGE | 3.4 | AVERAGE | 3.3 |
| 1.5 | 1D1 | 3.1 | 2D1 | 2.9 | 3D1 | 3.3 |
| | 1D2 | 3.5 | 2D2 | 3.0 | 3D2 | 3.9 |
| | 1D3 | 3.4 | 2D3 | 3.6 | 3D3 | 3.3 |
| | 1D4 | 3.0 | 2D4 | 3.2 | 3D4 | 3.4 |
| | 1D5 | 3.3 | 2D5 | 3.2 | 3D5 | 3.2 |
| | 1D6 | 3.5 | 2D6 | 3.8 | 3D6 | 2.9 |
| | 1D7 | 2.8 | 2D7 | 3.3 | 3D7 | 3.3 |
| | 1D8 | 3.1 | 2D8 | 3.2 | 3D8 | 3.0 |
| | 1D9 | 2.0 | 2D9 | 3.4 | 3D9 | 2.7 |
| | AVERAGE | 3.1 | AVERAGE | 3.3 | AVERAGE | 3.2 |

| | | | | | |
|---|---|---|---|---|---|
| 1.0 | Not Produced | 2E1 | 3.1 | 3E1 | 3.6 |
| | | 2E2 | 3.6 | 3E2 | 4.0 |
| | | 2E3 | 3.3 | 3E3 | 3.3 |
| | | 2E4 | 3.4 | 3E4 | 3.3 |
| | | 2E5 | 3.0 | 3E5 | 3.6 |
| | | 2E6 | 3.3 | 3E6 | 3.4 |
| | | 2E7 | 3.7 | 3E7 | 3.9 |
| | | 2E8 | 3.7 | 3E8 | 3.5 |
| | | 2E9 | 3.0 | 3E9 | 3.7 |
| | | AVERAGE | 3.3 | AVERAGE | 3.6 |

As can be seen in Tables 3, 4, 5, 6, 7 and 8, the DMDEE catalyst allows bonded foam of similar physical characteristics to be produced with a steam time of 1.0 minutes when the minimum steam time is 1.5 minutes without the DMDEE catalyst. Thus, the utilization of the DMDEE catalyst shows about a 33 percent decrease in required steam time for 4 pcf foam logs, which equates to a 50 percent increase in the throughput rate of the steaming step for the foam logs (i.e. 1/.67=1.5). The increase in the throughput rate is most noticeable in a continuous production process such as the one hereinabove described.

In addition, because the properties of the injecting steam were not altered between the different experimental samples, the reduction in steam time also correlates to a reduction in the amount of moisture injected into the foam log. Reducing the amount of moisture injected into the foam log is beneficial because it reduces the costs of producing the foam log. Reducing the amount of moisture injected into a foam log is also beneficial because it reduces the drying time associated with the foam log. Thus, the DMDEE catalyst improves the bonded foam production process in three ways: it increases the rate of production by reducing the steam time required to cure the foam log, it decreases the cost of production by reducing the amount of moisture required to cure the foam log, and it increases the rate of production by reducing the drying time for the foam log.

### EXAMPLE TWO

Based on the results of the first experiment using the 4 pcf bonded foam, a second experiment was conducted using 8 pcf bonded foam samples. The experiment used the same three pre-polymers prepared in the same manner as the first experiment. The pre-polymers were coated on shredded foam as follows: 115 pounds of pre-polymer was added to a foam mixture comprising 150 pounds of prime polyurethane foam, 150 pounds of nitrile rubber foam, and 560 pounds of reclaimed bonded foam. Current processing methods indicate that a 3-minute minimum steam time is required for 8 pcf bonded foam, so the control group received a 3-minute steam time. Because the DMDEE catalyst produces about a 33 percent decrease in steam time, the foam containing the other two pre-polymer batches received a 2-minute steam time. Test samples were collected from the outside and the core of the foam logs in the same manner as the first experiment. Core and outside samples were collected for physical property comparison between the two areas of the foam log. The samples were sent to the same laboratory for the same tests as the first experiment, using the same testing standards. The results of these tests are illustrated in Tables 9, 10, 11, 12, 13, and 14 below.

TABLE 9

| Steam | | | | |
|---|---|---|---|---|
| Time | | | | |
| (minutes); | Batch 1 | | Batch 2 | Batch 3 |
| Location | Compression | | Compression | Compression |
| of Sample | Set @ 50% (%) | | Set @ 50% (%) | Set @ 50% (%) |
| 3.0; | 1C11 | 16.5 | Not Produced | Not Produced |
| Edge of | 1C12 | 15.5 | | |
| Log | 1C13 | 16.5 | | |
| | 1C14 | 15.9 | | |
| | 1C15 | 16.2 | | |
| | 1C16 | 17.0 | | |
| | 1C17 | 15.9 | | |
| | 1C18 | 17.0 | | |
| | 1C19 | 17.4 | | |
| | AVER- | 16.4 | | |
| | AGE | | | |
| 3.0; | 1C21 | 13.2 | Not Produced | Not Produced |
| Core of | 1C22 | 12.5 | | |
| Log | 1C23 | 12.2 | | |
| | 1C24 | 12.3 | | |
| | 1C25 | 12.8 | | |
| | 1C26 | 10.8 | | |
| | 1C27 | 14.3 | | |
| | 1C28 | 14.2 | | |
| | 1C29 | 14.8 | | |
| | AVER- | 13.0 | | |
| | AGE | | | |

| | | | | | |
|---|---|---|---|---|---|
| 3.0; | Not Produced | 3D11 | 15.3 | 2D11 | 14.8 |
| Edge of | | 3D12 | 17.0 | 2D12 | 15.9 |
| Log | | 3D13 | 15.5 | 2D13 | 15.4 |
| | | 3D14 | 14.7 | 2D14 | 19.1 |
| | | 3D15 | 15.3 | 2D15 | 18.6 |
| | | 3D16 | 15.2 | 2D16 | 14.0 |
| | | 3D17 | 15.4 | 2D17 | 14.8 |
| | | 3D18 | 15.4 | 2D18 | 15.4 |
| | | 3D19 | 15.5 | 2D19 | 16.2 |
| | | AVERAGE | 15.5 | AVERAGE | 16.0 |
| 3.0; | Not Produced | 3D21 | 12.1 | 2D21 | 12.0 |
| Core of | | 3D22 | 12.4 | 2D22 | 11.8 |
| Log | | 3D23 | 12.5 | 2D23 | 12.5 |
| | | 3D24 | 11.6 | 2D24 | 11.5 |
| | | 3D25 | 13.5 | 2D25 | 14.4 |
| | | 3D26 | 13.2 | 2D26 | 12.2 |
| | | 3D27 | 15.3 | 2D27 | 13.5 |
| | | 3D28 | 12.5 | 2D28 | 13.1 |
| | | 3D29 | 14.1 | 2D29 | 12.0 |
| | | AVERAGE | 13.0 | AVERAGE | 12.6 |

TABLE 10

| Steam | | | | |
|---|---|---|---|---|
| Time | | | | |
| (minutes); | Batch 1 | | Batch 2 | Batch 3 |
| Location | CFD @ 65% | | CFD @ 65% | CFD @ 65% |
| of Sample | (%) | | (%) | (%) |
| 3.0; | 1C11 | 23.4 | Not Produced | Not Produced |
| Edge of | 1C12 | 31.3 | | |
| Log | 1C13 | 32.2 | | |
| | 1C14 | 40.9 | | |
| | 1C15 | 41.4 | | |
| | 1C16 | 41.6 | | |
| | 1C17 | 41.7 | | |
| | 1C18 | 43.7 | | |
| | 1C19 | 33.3 | | |
| | AVER- | 36.6 | | |
| | AGE | | | |
| 3.0; | 1C21 | 37.9 | Not Produced | Not Produced |
| Core of | 1C22 | 42.2 | | |
| Log | 1C23 | 45.3 | | |
| | 1C24 | 43.6 | | |
| | 1C25 | 45.7 | | |
| | 1C26 | 49.8 | | |
| | 1C27 | 46.3 | | |
| | 1C28 | 49.5 | | |
| | 1C29 | 57.5 | | |
| | AVER- | 46.4 | | |
| | AGE | | | |

| | | | | | |
|---|---|---|---|---|---|
| 3.0; | Not Produced | 3D11 | 35.3 | 2D11 | 38.2 |
| Edge of | | 3D12 | 22.6 | 2D12 | 40.6 |
| Log | | 3D13 | 43.8 | 2D13 | 25.9 |
| | | 3D14 | 33.9 | 2D14 | 32.1 |
| | | 3D15 | 33.1 | 2D15 | 29.4 |
| | | 3D16 | 42.1 | 2D16 | 40.6 |
| | | 3D17 | 29.9 | 2D17 | 37.6 |
| | | 3D18 | 42.5 | 2D18 | 47.0 |
| | | 3D19 | 41.2 | 2D19 | 45.9 |
| | | AVERAGE | 36.0 | AVERAGE | 37.5 |
| 3.0; | Not Produced | 3D21 | 43.1 | 2D21 | 39.9 |
| Core of | | 3D22 | 43.2 | 2D22 | 34.9 |
| Log | | 3D23 | 44.3 | 2D23 | 38.7 |
| | | 3D24 | 43.9 | 2D24 | 43.7 |
| | | 3D25 | 43.4 | 2D25 | 39.2 |
| | | 3D26 | 41.0 | 2D26 | 41.4 |
| | | 3D27 | 42.6 | 2D27 | 53.3 |
| | | 3D28 | 42.6 | 2D28 | 48.5 |
| | | 3D29 | 46.3 | 2D29 | 55.9 |
| | | AVERAGE | 43.4 | AVERAGE | 44.0 |

TABLE 11

| Steam | | | | |
|---|---|---|---|---|
| Time | | | | |
| (minutes); | Batch 1 | | Batch 2 | Batch 3 |
| Location | Tear Die C | | Tear Die C | Tear Die C |
| of Sample | (N/m) | | (N/m) | (N/m) |
| 3.0; | 1C11 | 381 | Not Produced | Not Produced |
| Edge of | 1C12 | 472 | | |
| Log | 1C13 | 547 | | |
| | 1C14 | 502 | | |
| | 1C15 | 516 | | |
| | 1C16 | 470 | | |
| | 1C17 | 510 | | |
| | 1C18 | 509 | | |
| | 1C19 | 475 | | |
| | AVER- | 487 | | |
| | AGE | | | |
| 3.0; | 1C21 | 518 | Not Produced | Not Produced |
| Core of | 1C22 | 561 | | |
| Log | 1C23 | 512 | | |
| | 1C24 | 402 | | |
| | 1C25 | 621 | | |
| | 1C26 | 394 | | |
| | 1C27 | 697 | | |
| | 1C28 | 470 | | |
| | 1C29 | 464 | | |
| | AVER- | 515 | | |
| | AGE | | | |

| | | | | | |
|---|---|---|---|---|---|
| 3.0; | Not Produced | 3D11 | 469 | 2D11 | 345 |
| Edge of | | 3D12 | 492 | 2D12 | 496 |
| Log | | 3D13 | 494 | 2D13 | 481 |
| | | 3D14 | 411 | 2D14 | 585 |
| | | 3D15 | 393 | 2D15 | 534 |
| | | 3D16 | 384 | 2D16 | 488 |
| | | 3D17 | 396 | 2D17 | 563 |
| | | 3D18 | 476 | 2D18 | 490 |
| | | 3D19 | 509 | 2D19 | 487 |
| | | AVERAGE | 447 | AVERAGE | 497 |
| 3.0; | Not Produced | 3D21 | 371 | 2D21 | 486 |
| Core of | | 3D22 | 459 | 2D22 | 494 |
| Log | | 3D23 | 560 | 2D23 | 544 |
| | | 3D24 | 426 | 2D24 | 555 |
| | | 3D25 | 446 | 2D25 | 512 |
| | | 3D26 | 396 | 2D26 | 579 |
| | | 3D27 | 480 | 2D27 | 543 |
| | | 3D28 | 495 | 2D28 | 439 |
| | | 3D29 | 458 | 2D29 | 712 |
| | | AVERAGE | 455 | AVERAGE | 540 |

TABLE 12

| Steam | | | | |
|---|---|---|---|---|
| Time | | | | |
| (minutes); | Batch 1 | | Batch 2 | Batch 3 |
| Location of | Tensile Strength | | Tensile Strength | Tensile Strength |
| Sample | (psi) | | (psi) | (psi) |
| 3.0; | 1C11 | 4.4 | Not Produced | Not Produced |
| Edge of | 1C12 | 5.3 | | |
| Log | 1C13 | 5.7 | | |
| | 1C14 | 6.0 | | |
| | 1C15 | 5.3 | | |
| | 1C16 | 5.0 | | |
| | 1C17 | 4.2 | | |
| | 1C18 | 5.3 | | |
| | 1C19 | 5.8 | | |
| | AVERAGE | 5.2 | | |
| 3.0; | 1C21 | 5.1 | Not Produced | Not Produced |
| Core of Log | 1C22 | 4.9 | | |
| | 1C23 | 5.3 | | |
| | 1C24 | 4.6 | | |
| | 1C25 | 5.8 | | |
| | 1C26 | 5.1 | | |
| | 1C27 | 4.4 | | |
| | 1C28 | 6.6 | | |
| | 1C29 | 6.3 | | |
| | AVERAGE | 5.3 | | |

| | | | | | |
|---|---|---|---|---|---|
| 3.0; | Not Produced | 3D11 | 3.6 | 2D11 | 5.3 |
| Edge of | | 3D12 | 5.2 | 2D12 | 5.9 |
| Log | | 3D13 | 5.0 | 2D13 | 5.2 |
| | | 3D14 | 4.2 | 2D14 | 4.7 |
| | | 3D15 | 4.5 | 2D15 | 5.6 |
| | | 3D16 | 4.6 | 2D16 | 5.1 |
| | | 3D17 | 4.1 | 2D17 | 6.2 |
| | | 3D18 | 3.3 | 2D18 | 5.4 |
| | | 3D19 | 5.3 | 2D19 | 4.6 |
| | | AVERAGE | 4.4 | AVERAGE | 5.3 |
| 3.0; | Not Produced | 3D21 | 3.2 | 2D21 | 4.3 |
| Core of Log | | 3D22 | 4.7 | 2D22 | 4.7 |
| | | 3D23 | 5.1 | 2D23 | 4.5 |
| | | 3D24 | 5.0 | 2D24 | 4.9 |
| | | 3D25 | 4.7 | 2D25 | 5.5 |
| | | 3D26 | 3.8 | 2D26 | 5.5 |
| | | 3D27 | 5.2 | 2D27 | 6.4 |
| | | 3D28 | 4.9 | 2D28 | 5.7 |
| | | 3D29 | 5.1 | 2D29 | 6.3 |
| | | AVERAGE | 4.6 | AVERAGE | 5.3 |

TABLE 13

| Steam Time | | | | |
|---|---|---|---|---|
| (minutes); | | | | |
| Location of | Batch 1 | | Batch 2 | Batch 3 |
| Sample | Elongation (%) | | Elongation (%) | Elongation (%) |
| 3.0; | 1C11 | 67 | Not Produced | Not Produced |
| Edge of Log | 1C12 | 72 | | |
| | 1C13 | 65 | | |
| | 1C14 | 80 | | |
| | 1C15 | 67 | | |
| | 1C16 | 73 | | |
| | 1C17 | 65 | | |
| | 1C18 | 75 | | |
| | 1C19 | 95 | | |
| | AVERAGE | 73 | | |
| 3.0; | 1C21 | 65 | Not Produced | Not Produced |
| Core of Log | 1C22 | 65 | | |
| | 1C23 | 65 | | |
| | 1C24 | 55 | | |
| | 1C25 | 85 | | |
| | 1C26 | 77 | | |
| | 1C27 | 67 | | |
| | 1C28 | 92 | | |
| | 1C29 | 98 | | |
| | AVERAGE | 74 | | |

| | | | | | |
|---|---|---|---|---|---|
| 3.0; | Not Produced | 3D11 | 47 | 2D11 | 58 |
| Edge of Log | | 3D12 | 85 | 2D12 | 78 |
| | | 3D13 | 72 | 2D13 | 67 |
| | | 3D14 | 63 | 2D14 | 70 |
| | | 3D15 | 68 | 2D15 | 98 |
| | | 3D16 | 73 | 2D16 | 75 |
| | | 3D17 | 37 | 2D17 | 87 |
| | | 3D18 | 47 | 2D18 | 45 |
| | | 3D19 | 83 | 2D19 | 55 |
| | | AVERAGE | 64 | AVERAGE | 70 |
| 3.0; | Not Produced | 3D21 | 38 | 2D21 | 55 |
| Core of Log | | 3D22 | 60 | 2D22 | 83 |
| | | 3D23 | 70 | 2D23 | 73 |
| | | 3D24 | 75 | 2D24 | 70 |
| | | 3D25 | 55 | 2D25 | 82 |
| | | 3D26 | 57 | 2D26 | 82 |
| | | 3D27 | 88 | 2D27 | 78 |
| | | 3D28 | 73 | 2D28 | 82 |
| | | 3D29 | 67 | 2D29 | 80 |
| | | AVERAGE | 65 | AVERAGE | 76 |

TABLE 14

| Steam Time | | | | |
|---|---|---|---|---|
| (minutes); | | | | |
| Location of | Batch 1 | | Batch 2 | Batch 3 |
| Sample | Density (pcf) | | Density (pcf) | Density (pcf) |
| 3.0; | 1C11 | 5.4 | Not Produced | Not Produced |
| Edge of Log | 1C12 | 6.9 | | |
| | 1C13 | 6.3 | | |
| | 1C14 | 6.9 | | |
| | 1C15 | 7.0 | | |
| | 1C16 | 7.3 | | |
| | 1C17 | 7.0 | | |
| | 1C18 | 7.1 | | |
| | 1C19 | 6.2 | | |
| | AVERAGE | 6.7 | | |
| 3.0; | 1C21 | 7.6 | Not Produced | Not Produced |
| Core of Log | 1C22 | 7.4 | | |
| | 1C23 | 7.3 | | |
| | 1C24 | 7.7 | | |
| | 1C25 | 7.2 | | |
| | 1C26 | 7.6 | | |
| | 1C27 | 8.0 | | |
| | 1C28 | 7.6 | | |
| | 1C29 | 7.4 | | |
| | AVERAGE | 7.5 | | |

| | | | | | |
|---|---|---|---|---|---|
| 3.0; | Not Produced | 3D11 | 6.9 | 2D11 | 7.1 |
| Edge of Log | | 3D12 | 5.3 | 2D12 | 7.2 |
| | | 3D13 | 7.3 | 2D13 | 6.0 |
| | | 3D14 | 6.7 | 2D14 | 6.5 |
| | | 3D15 | 6.4 | 2D15 | 6.6 |
| | | 3D16 | 7.1 | 2D16 | 6.9 |
| | | 3D17 | 6.4 | 2D17 | 6.9 |
| | | 3D18 | 6.9 | 2D18 | 7.8 |
| | | 3D19 | 7.3 | 2D19 | 7.4 |
| | | AVERAGE | 6.7 | AVERAGE | 6.9 |
| 3.0; | Not Produced | 3D21 | 7.2 | 2D21 | 7.3 |
| Core of Log | | 3D22 | 7.2 | 2D22 | 7.2 |
| | | 3D23 | 7.2 | 2D23 | 7.4 |
| | | 3D24 | 7.3 | 2D24 | 7.4 |
| | | 3D25 | 7.0 | 2D25 | 6.9 |
| | | 3D26 | 7.2 | 2D26 | 7.6 |
| | | 3D27 | 7.2 | 2D27 | 8.4 |
| | | 3D28 | 7.4 | 2D28 | 7.6 |
| | | 3D29 | 7.2 | 2D29 | 8.0 |
| | | AVERAGE | 7.2 | AVERAGE | 7.5 |

As can be seen in Tables 9, 10, 11, 12, 13, and 14, the steam time for the foam logs containing the DMDEE catalyst were able to be reduced while the physical properties of the samples using the DMDEE catalyst were comparable to the control group. In fact, the tensile and tear properties of the bonded foam containing the DMDEE catalyst were better than the control group. In addition, the POLYMERIC 199 MDI produced slightly better physical properties, although both the POLYMERIC 199 and the RUBINATE 9041 MDI produced foam logs with physical properties that are comparable to the control foam log. As expected, there is a slight difference in physical properties from the core of the log to the outside, probably due to density differences and steam penetration. At the core, the density is slightly higher compared to the outside. As a result, core samples had slightly better physical properties compared to the outside. These differences, though, were in line with the differences seen in the control group. Also, there were slight differences in physical properties seen between the top and bottom of the log. Slightly better physical properties were seen on the bottom of the log compared to the top, probably due to higher densities on the bottom and the introduction of steam for curing from the bottom of the log. Again, these differences were in line with the differences seen in the control group. Thus, the DMDEE catalyst was able to produce comparable bonded foam logs with less steam time than the control group. The reduction in steam time for the 8 pcf foam log produces the same benefits as the reduction in steam time for the 4 pcf foam log.

While a number of preferred embodiments of the invention have been shown and described herein, modifications thereof may be made by one skilled in the art without departing from the spirit and the teachings of the invention. The embodiments described herein are exemplary only and are not intended to be limiting. Many variations, combinations, and modifications of the invention disclosed herein are possible and are within the scope of the invention. Accordingly, the scope of protection is not limited by the description set out above, but is defined by the claims which follow, that scope including all equivalents of the subject matter of the claims.

What is claimed is:

1. A pre-polymer comprising: isocyanate, polyol, oil, and an amine catalyst.

2. The pre-polymer of claim 1 wherein the amine catalyst is dimorpholinodiethylether (DMDEE).

3. The pre-polymer of claim 2 wherein the pre-polymer contains between about 25 percent, by weight, and about 40 percent, by weight, of each of the following: the isocyanate, the polyol, and the oil.

4. The pre-polymer of claim 2 wherein the pre-polymer contains between about 30 percent, by weight, and about 36 percent, by weight, of the isocyanate, the polyol, and the oil.

5. The pre-polymer of claim 4 wherein the pre-polymer contains between about 0.5 percent, by weight, and about 5 percent, by weight, of the amine catalyst.

6. The pre-polymer of claim 5 wherein the ratio of catalyst to polyol is between about 1:20 and about 1:40.

7. The pre-polymer of claim 6 wherein the pre-polymer has a viscosity between about 100 centipoises and 1,000 centipoises.

8. The pre-polymer of claim 7 wherein the pre-polymer has a viscosity between about 400 centipoises and 600 centipoises.

9. The pre-polymer of claim 8 further comprising an antimicrobial chemical compound.

10. The pre-polymer of claim 9 further comprising a flame retardant (FR) chemical compound.

11. A method for producing a polyurethane foam product comprising:
coating a plurality of foam pieces with the pre-polymer of claim 9;
compressing the foam pieces into a foam log of a desired density; and
steaming the foam log to cure the pre-polymer.

12. The method of claim 11 wherein the inclusion of the catalyst reduces the cure time for the foam log by thirty percent over methods not employing the catalyst.

13. The method of claim 11 wherein the inclusion of the catalyst reduces the amount of steam required to cure the foam log by thirty percent over methods not employing the catalyst.

14. The method of claim 12 wherein the foam log is made in a continuous extruder.

15. The method of claim 14 wherein the foam pieces are substantially moisture-free.

16. A bonded foam underlayment manufactured according to the method of claim 15.

17. A method for producing a polyurethane foam product comprising:
coating a plurality of foam pieces with a pre-polymer;
compressing the foam pieces into a foam log of a desired density;
steaming the foam log to cure the pre-polymer; and
wherein the pre-polymer comprises isocyanate, polyol, and an amine catalyst.

18. The method of claim 17 wherein the inclusion of the catalyst reduces the cure time for the foam log by thirty percent over methods not employing the catalyst.

19. The method of claim 17 wherein the inclusion of the catalyst reduces the amount of steam required to cure the foam log by thirty percent over methods not employing the catalyst.

20. The method of claim 17 wherein the foam log is made in a continuous extruder.

21. The method of claim 17 wherein the foam pieces are substantially moisture-free.

22. The method of claim 17 wherein the amine catalyst is dimorpholinodiethylether (DMDEE).

23. The method of claim 17 wherein the pre-polymer further comprises an antimicrobial chemical compound.

24. The method of claim 17 wherein the pre-polymer further comprises a flame retardant (FR) chemical compound.

25. The method of claim 17 wherein the pre-polymer contains between about 20 percent, by weight, and about 50 percent, by weight, of each of the following: the isocyanate and the polyol.

26. The method of claim 17 wherein the pre-polymer contains about equal amounts of the isocyanate and the polyol.

27. The method of claim 17 wherein the pre-polymer has a viscosity between about 100 centipoises and 1,000 centipoises.

28. The method of claim 17 wherein the pre-polymer has a viscosity between about 400 centipoises and 600 centipoises.

29. The method of claim 17 wherein the pre-polymer further comprises oil.

30. The method of claim 29 wherein the pre-polymer contains between about 25 percent, by weight, and about 40 percent, by weight, of each of the following: the isocyanate, the polyol, and the oil.

31. The method of claim 29 wherein the pre-polymer contains between about 30 percent, by weight, and about 36 percent, by weight, of the isocyanate, the polyol, and the oil.

32. The method of claim 31 wherein the pre-polymer contains between about 0.5 percent, by weight, and about 5 percent, by weight, of the amine catalyst.

33. The method of claim 17 wherein the ratio of catalyst to polyol is between about 1:20 and about 1:40.

34. A bonded foam underlayment manufactured according to the method of claim 17.

35. A method for producing a polyurethane foam product comprising:
coating a plurality of foam pieces with a pre-polymer;
compressing the foam pieces into a foam log of a desired density;
steaming the foam log to cure the pre-polymer;
wherein the pre-polymer comprises isocyanate, polyol, oil, and a dimorpholinodiethylether (DMDEE) catalyst;
wherein the pre-polymer contains between about 30 percent, by weight, and about 36 percent, by weight, of the isocyanate, the polyol, and the oil; and
wherein the pre-polymer contains between about 0.5 percent, by weight, and about 5 percent, by weight, of the catalyst.

36. The method of claim 35 wherein the inclusion of the catalyst reduces the cure time for the foam log by thirty percent over methods not employing the catalyst.

37. The method of claim 35 wherein the inclusion of the catalyst reduces the amount of steam required to cure the foam log by thirty percent over methods not employing the catalyst.

38. The method of claim 36 wherein the foam log is made in a continuous extruder.

39. The method of claim 38 wherein the foam pieces are substantially moisture-free.

40. The method of claim 39 wherein the pre-polymer further comprises an antimicrobial chemical compound.

41. The method of claim 40 wherein the pre-polymer further comprises a flame retardant (FR) chemical compound.

42. The method of claim 40 wherein the pre-polymer has a viscosity between about 100 centipoises and 1,000 centipoises.

43. The method of claim 40 wherein the pre-polymer has a viscosity between about 400 centipoises and 600 centipoises.

44. The method of claim 43 wherein the ratio of catalyst to polyol is between about 1:20 and about 1:40.

45. A bonded foam underlayment manufactured according to the method of claim 35.
